(19) United States
(12) Patent Application Publication
(10) Pub. No.: US 2025/0251125 A1
(43) Pub. Date: Aug. 7, 2025

(54) INTEGRATED ILLUMINATED FAN

(71) Applicant: SHENZHEN APALTEK CO., LTD., Shenzhen (CN)

(72) Inventor: Dagao ZHENG, Shenzhen (CN)

(21) Appl. No.: 18/622,834

(22) Filed: Mar. 29, 2024

(30) Foreign Application Priority Data
Feb. 1, 2024 (CN) 2024101489220

(51) Int. Cl. F21V 33/00; F04D 25/16; F04D 29/32; F04D 29/52; F04D 29/54; F04D 29/60; F21V 8/00; F21V 23/02; F21Y 103/10; F21Y 113/00; F21Y 115/10

(52) U.S. Cl. CPC F21V 33/0096; F04D 25/166; F04D 29/005; F04D 29/522; F04D 29/601; F21V 23/02; G02B 6/0051; G02B 6/0081; F04D 19/002; F04D 25/0613; F04D 29/646; F21Y 2103/10; F21Y 2113/00; F21Y 2115/10

(57) ABSTRACT

An integrated illuminated fan includes a conjoined base, a conjoined fan frame, fans and a lighting structure. The conjoined base is disposed with bearing portions which are arranged at intervals. The conjoined fan frame is connected with the conjoined base and disposed with vane wheel chambers. The vane wheel chamber is arranged correspondingly to the bearing portion. The fan includes a stator assembly and a vane wheel. The stator assembly is separately disposed on the bearing portion. The vane wheel is separately accommodated in the vane wheel chamber and connected correspondingly to the stator assembly. The lighting structure is disposed in the conjoined base and electrically connected to the stator assembly. Thereby, it has a simple structure and can be assembled easily and improve the overall cooling performance.

### BACKGROUND

### Technical Field

The disclosure relates to a technology of illuminated fans, particularly to an integrated illuminated fan.

### Related Art

The development of computer devices is rapid, and the application of computer devices can be seen everywhere and has become what is called a computer today. Computers have a variety of execution and calculation functions that can meet people's needs. For example, personal computers have functions such as entertainment, word processing, and image playback in family life. Industrial computers provide control, supervision, and computing services for factory operations. Automotive computers provide drivers and passengers with multimedia entertainment and the ability to receive information in real time. Overall, computers have become an indispensable device in human social life.

In addition, as the demand for computer specifications increases day by day, more and more attention is paid to the heat dissipation inside a computer case. Therefore, when assembling the computer, most users will add fans to dissipate the accumulated heat energy in the computer case outward. Also, the transparent arrangement of computer cases allows users to further see through the actual operating conditions of various inside components or elements during operation. Therefore, fan devices with a lighting function have been gradually adopted.

However, fan devices with a lighting function have the following problems in actual use. Since each fan and lighting unit must be connected to the power supply through wires, a limited amount of power connections provided by the power supply will inevitably affect the number of fans and lighting units that can be assembled. It will also make it difficult to arrange or manage wires as the number of internal circuits inside the computer case increases.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

An object of the disclosure is to provide an integrated illuminated fan, which has a simple structure and can be assembled easily and improve the overall cooling performance.

To accomplish the above object, the disclosure provides an integrated illuminated fan, which includes a conjoined base, a conjoined fan frame, multiple fans and a lighting structure. The conjoined base is disposed with multiple bearing portions which are arranged at intervals. The conjoined fan frame is connected with the conjoined base and disposed with multiple vane wheel chambers. Each vane wheel chamber is arranged correspondingly to each bearing portion. Each fan includes a stator assembly and a vane wheel. Each stator assembly is separately disposed on each bearing portion. Each vane wheel is separately accommodated in each vane wheel chamber and connected correspondingly to each stator assembly. The lighting structure is disposed in the conjoined base and electrically connected to the stator assembly.

The disclosure further has the following functions. The conjoined base and the conjoined fan frame are made by plastic one-piece injection molding, the appearance is simple and clean, the times of multiple fans installation and the costs of screws installation can be reduced, and the system assembling is easy to reduce the assembling risk. By the assembling or the arts of multiple plastic molding of the conjoined fan frame and the light output structure, the assembling positioning is accurate to avoid large errors and difficult installation of multiple fans combination to affect the lighting effect, the structure is firm, and the reliability is better. By the arrangement of each fan, it is beneficial to production in the same batch, the assembling and uniformity of products are excellent, independent packing is available, the packing costs and material recycling can be reduced, and recycling is easier.

### BRIEF DESCRIPTION OF THE DRAWINGS

FIG. 1 is an exploded view of the light output structure of the disclosure;

FIG. 2 is an exploded view of the conjoined fan frame and the light output structure of the disclosure;

FIG. 3 is an assembled view of the fan and the lighting structure of the disclosure;

FIG. 4 is a top view of FIG. 3;

FIG. 5 is an exploded view of the conjoined base, the fan and the lighting structure of the disclosure;

FIG. 6 is an exploded view of the integrated illuminated fan of the disclosure;

FIG. 7 is a perspective view of the integrated illuminated fan of the disclosure;

FIG. 8 is an assembled top view of the integrated illuminated fan of the disclosure; and

FIG. 9 is an assembled cross-sectional view of the integrated illuminated fan of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

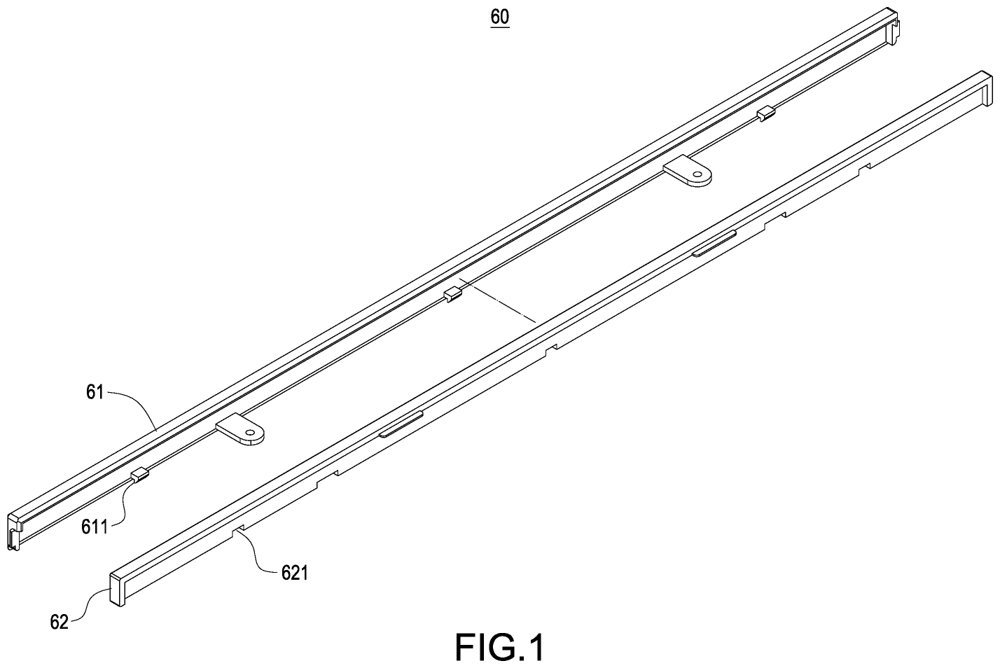

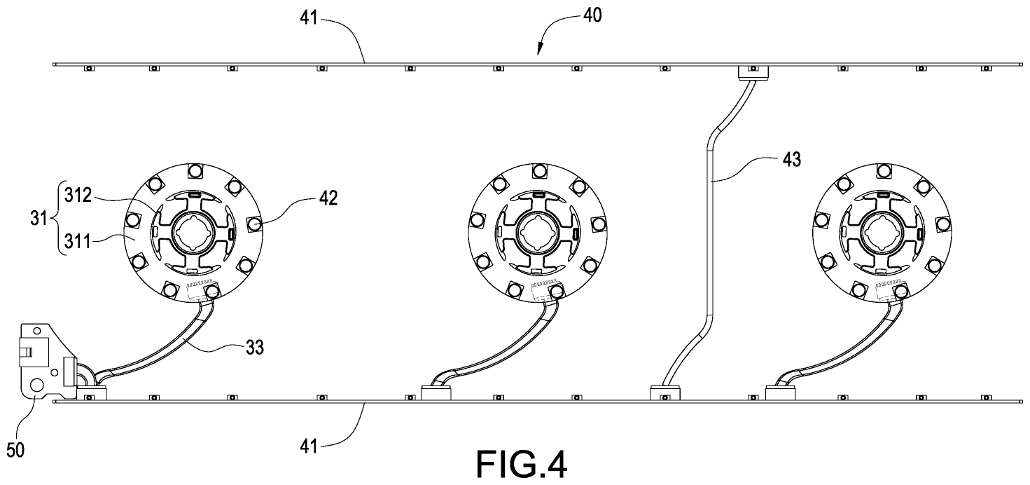

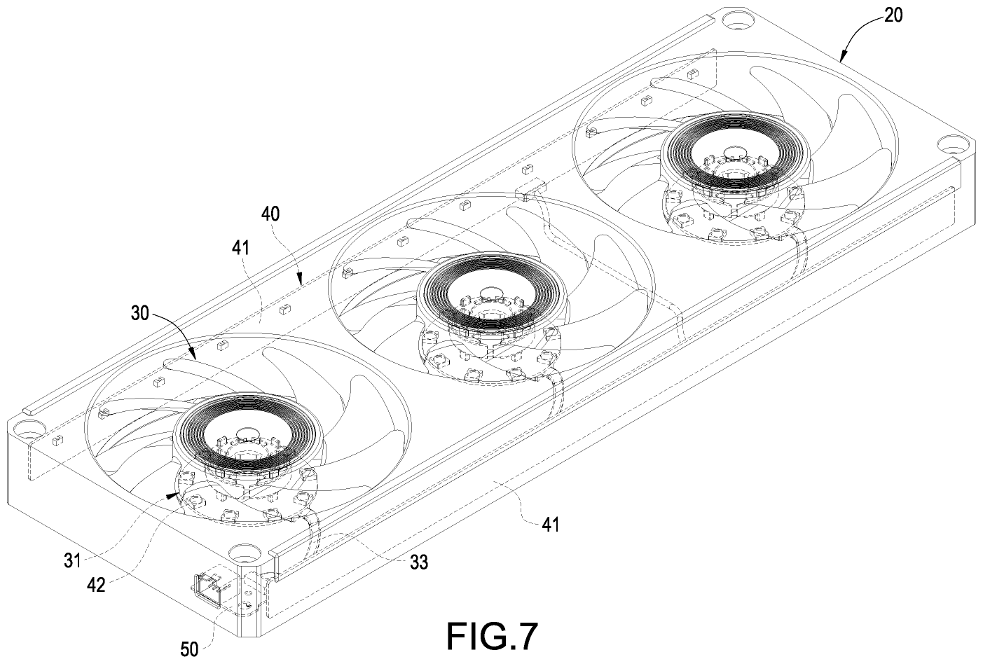

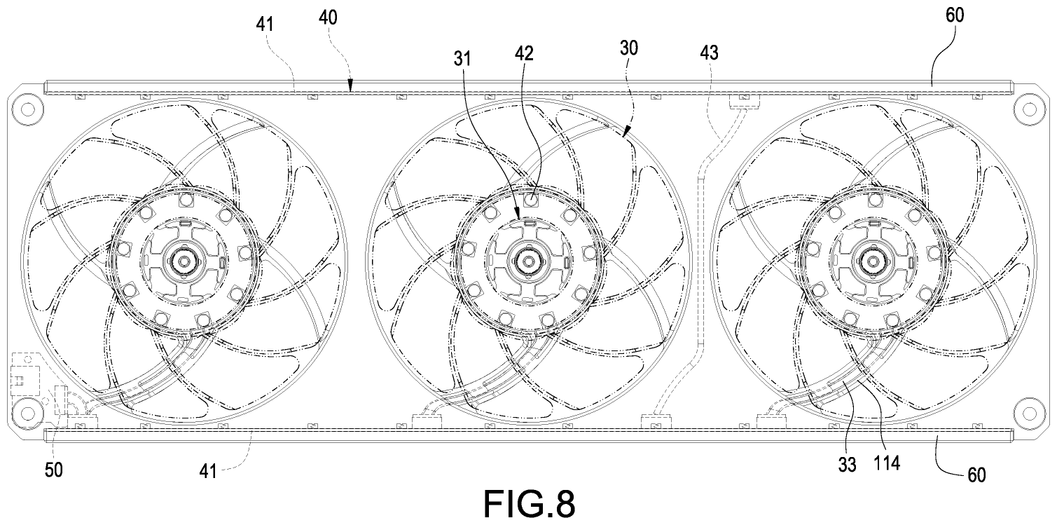

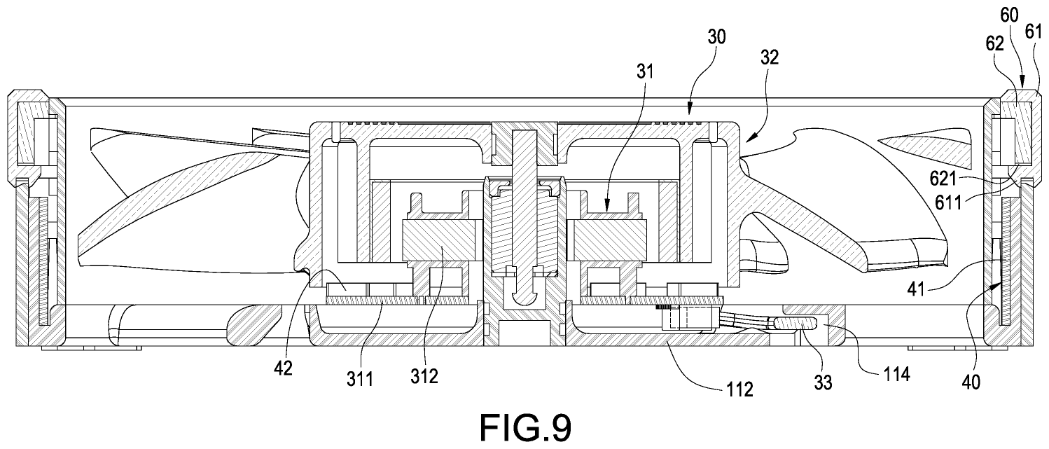

Please refer to FIGS. 1-9. The disclosure provides an integrated illuminated fan, which includes a conjoined base 10, a conjoined fan frame 20, multiple fans 30 and a lighting structure 40.

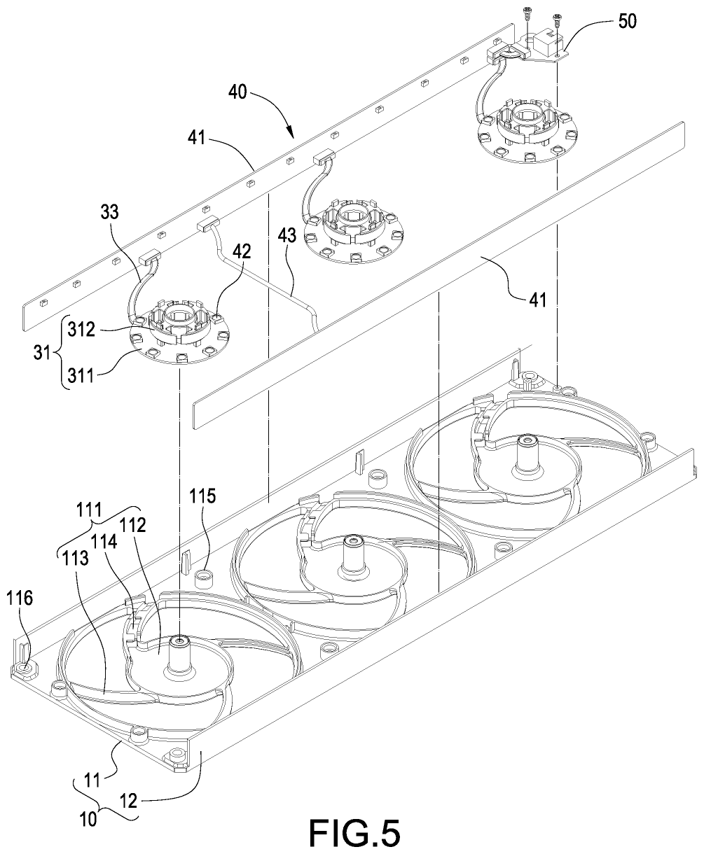

Please refer to FIG. 5. The conjoined base 10 is formed by plastic one-piece injection molding through molds and includes a bottom plate 11 and two side plates 12 bendingly extended from the bottom plate 11. The bottom plate 11 is disposed with multiple bearing portions 111. In the embodiment, the bearing portions 111 are, but not limited to, three in number, two, four or more are also available. Each bearing portion 111 is arranged at regular intervals.

In an embodiment, each bearing portion 111 includes a load tray 112 and multiple support rods 113 connected with the load tray 112. One of the support rods 113 is disposed with a wire trench 114. Two ends (the head end and the tail end) and the middle area of the bottom plate 11 are separately disposed with multiple sleeves 115. Four corners of the bottom plate 11 are separately disposed with a positioning pole 116.

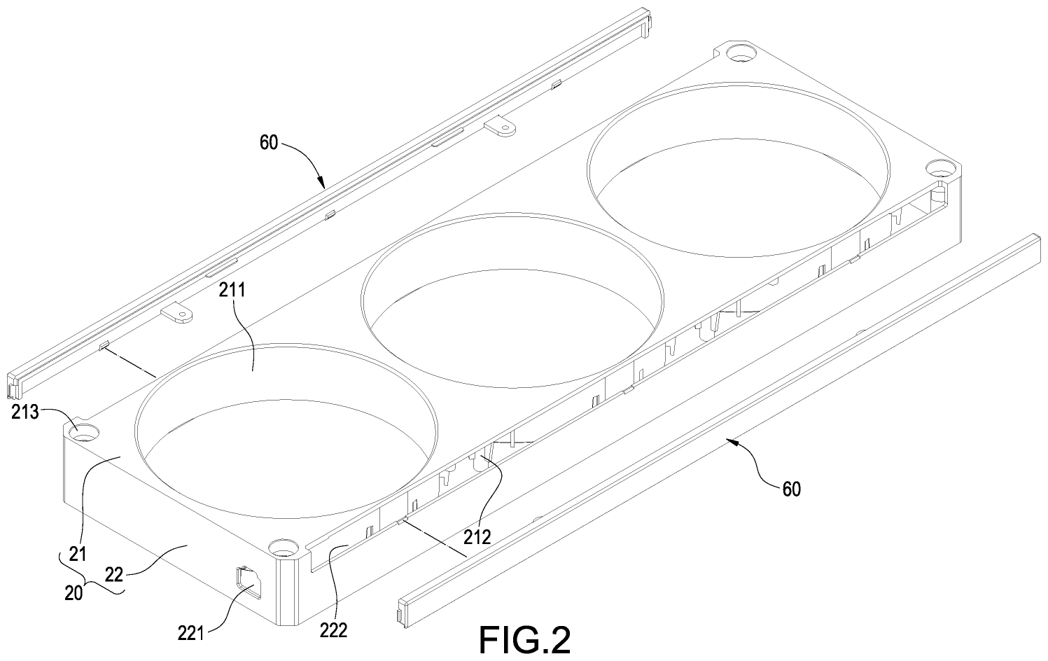

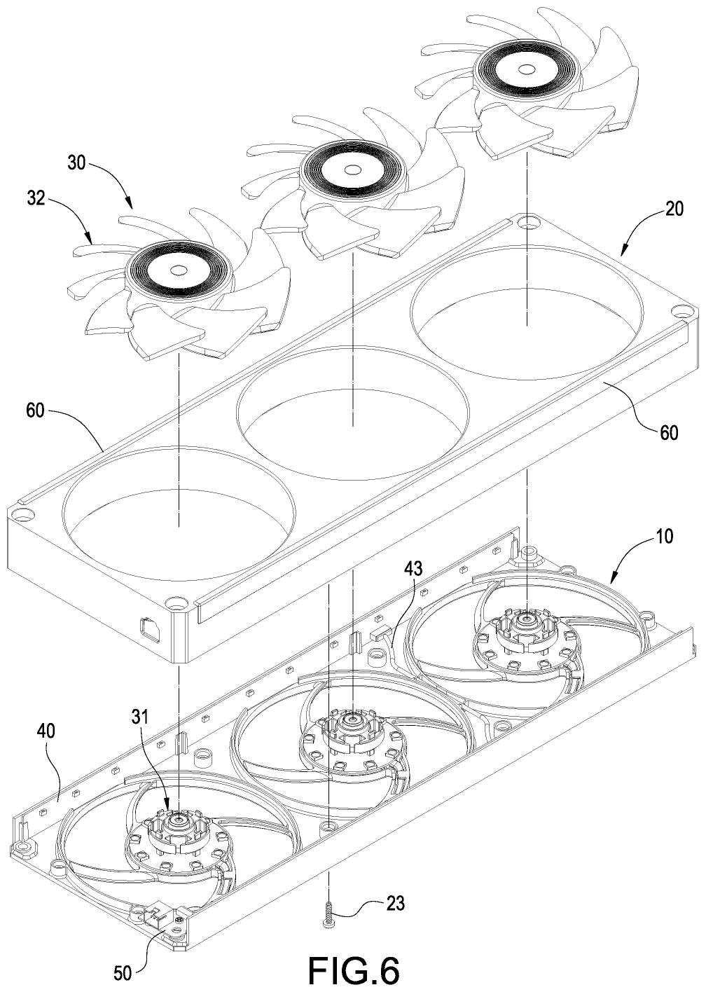

Please further refer to FIGS. 2 and 6. The conjoined fan frame 20 is connected with the conjoined base 10. The conjoined fan frame 20 is also formed by plastic one-piece injection molding through molds and includes a top plate 21 and multiple surrounding plates 22 bendingly extended from the top plate 21. The top plate 21 is disposed with multiple vane wheel chambers 211. In the embodiment, the vane wheel chambers 211 are, but not limited to, three in number, two, four or more are also available. Each vane wheel chamber 211 is arranged at regular intervals. Each vane wheel chamber 211 is arranged correspondingly to the bearing portion 111.

In an embodiment, one of the surrounding plates 22 is disposed with a jack 221. Other opposite two of the surrounding plates 22 are separately disposed with an elongated trench 222. Also, the top plate 21 is disposed with multiple threaded poles 212 in the direction toward the bottom plate 11. Each threaded pole 212 separately corresponds to each sleeve 115 to be inserted and connected for providing a screwing element 23 (as shown in FIG. 6) to pass through the sleeve 115 to be screwed to the threaded pole 212. Further, four corners of the top plate 21 are separately disposed with a countersink 213 for being embedded and positioned with the positioning pole 116.

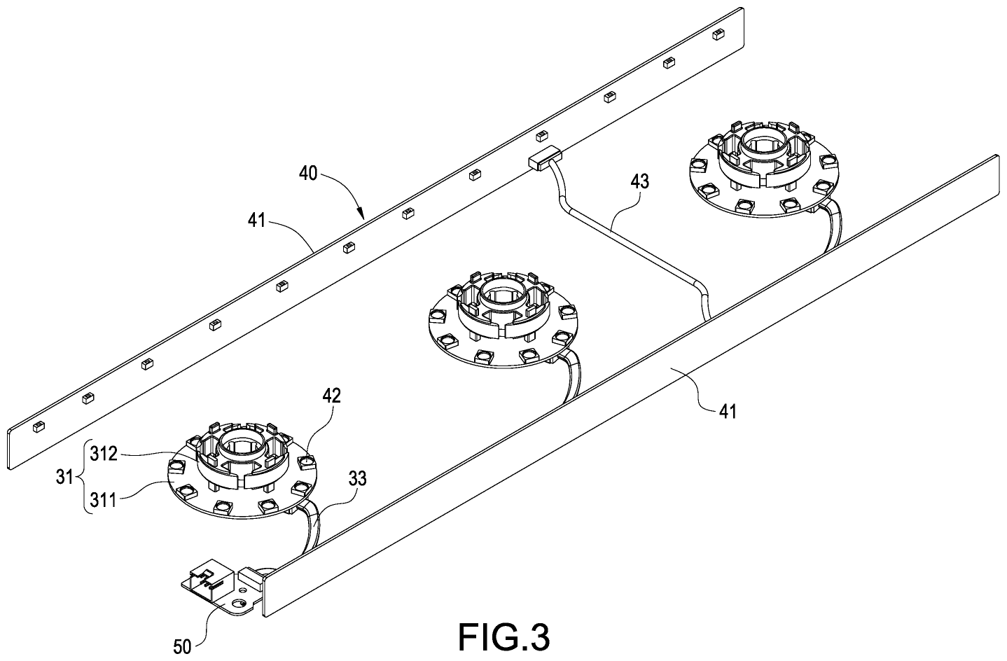

Please further refer to FIGS. 3-6. Each fan 30 includes a stator assembly 31 and a vane wheel 32. Each stator assembly 31 is separately disposed on each bearing portion 111. Each vane wheel 32 is separately accommodated in each vane wheel chamber 211 and connected correspondingly to each stator assembly 31. The vane wheel 32 includes related elements such as a hub, vanes, a rotator, a shaft, etc.

In an embodiment, each stator assembly 31 includes a circuit board 311, a winding 312 disposed over and electrically connected with the circuit board 311 and a conductive wire 313 electrically connected with the circuit board 311. The winding 312 includes a silicon lamination, coils, etc. Each circuit board 311 is separately disposed over each load tray 112. Each conductive wire 313 separately passes through the wire trench 114 of each support rod 113.

In an embodiment, the lighting structure 40 includes two LED strips 41. Each LED strip 41 is disposed inside each side plate 12 of the conjoined base 10 and electrically connected to the stator assembly 31 through each conductive wire 313.

In an embodiment, the lighting structure 40 further includes multiple illuminators 42 disposed on the circuit board 311 of the stator assembly 31. Each illuminator 42 is arranged on the circuit board 311 in a surrounding manner. The illuminator 42 may be a light-emitting diode (LED).

In an embodiment, the lighting structure 40 further includes a connecting wire 43. Two ends of the connecting wire 43 are separately electrically connected to each LED strip 41.

In an embodiment, the integrated illuminated fan of the disclosure further includes a power input assembly 50 which is electrically connected to the lighting structure 40 and corresponds to the jack 221 of the conjoined fan frame 20 to be disposed.

Please refer to FIGS. 1 and 2. The integrated illuminated fan of the disclosure further includes a light output structure 60 disposed in the elongated trench 222 of the conjoined fan frame 20.

In an embodiment, the light output structure 60 includes a light guide plate 61 and a diffuser 62. The light guide plate 61 is covered on an outer surface of the diffuser 62. The light guide plate 61 is disposed with multiple hooks 611. The diffuser 62 is disposed with multiple notches 621 corresponding to each hook 611. Each hook 611 passes through each notch 621 first and then is engaged with and fixed to the surrounding plates 22 of the conjoined fan frame 20.

Please refer to FIGS. 6-9. When assembling, each stator assembly 31 is separately disposed on each bearing portion 111. Each conductive wire 33 separately passes through each wire trench 114 first and then is electrically connected to each LED strip 41. Each vane wheel 32 corresponds to each stator assembly 31 to be installed. The light output structure 60 corresponds to each elongated trench 222 of the conjoined fan frame 20 to be installed, is aligned with each sleeve 115 of the conjoined base 10 to be embedded through each threaded pole 212 of the conjoined fab frame 20, and is fastened and connected by each screwing element 23, so as to simplify the overall assembling process.

When using, the light emitted from each illuminator 42 is reflected and illuminated by the rotating vane wheel 32, and the light emitted from each LED strip 41 is reflected and illuminated by the light output structure 60, so as to effectively enrich the overall lighting effect.

While this disclosure has been described by means of specific embodiments, numerous modifications and variations could be made thereto by those skilled in the art without departing from the scope and spirit of this disclosure set forth in the claims.

What is claimed is:

1. An integrated illuminated fan comprising:
a conjoined base, disposed with multiple bearing portions which are arranged at intervals;
a conjoined fan frame, connected with the conjoined base, disposed with multiple vane wheel chambers, and each vane wheel chamber being arranged correspondingly to each bearing portion;
multiple fans, each fan comprising a stator assembly and a vane wheel, each stator assembly being separately disposed on each bearing portion, each vane wheel being separately accommodated in each vane wheel chamber and connected correspondingly to each stator assembly; and
a lighting structure, disposed in the conjoined base and electrically connected to the stator assembly.

2. The integrated illuminated fan of claim 1, wherein the lighting structure comprises multiple LED strips and a connecting wire electrically connected to each LED strip, the conjoined base comprises multiple side plates, each stator assembly comprises a conductive wire, and each LED strip is disposed inside each side plate and electrically connected to each stator assembly through each conductive wire.

3. The integrated illuminated fan of claim 2, wherein each stator assembly further comprises a circuit board electrically connected with the conductive wire, the lighting structure further comprises multiple illuminators disposed on each circuit board, and each illuminator is arranged on the circuit board in a surrounding manner.

4. The integrated illuminated fan of claim 1, further comprising a power input assembly, wherein the conjoined fan frame is disposed with a jack, and the power input assembly is electrically connected to the lighting structure and corresponds to the jack of the conjoined fan frame to be disposed.

5. The integrated illuminated fan of claim 1, further comprising a light output structure, wherein the conjoined fan frame is disposed with an elongated trench, and the light output structure is disposed in the elongated trench of the conjoined fan frame.

6. The integrated illuminated fan of claim 5, wherein the light output structure comprises a light guide plate and a diffuser, and the light guide plate is covered on an outer surface of the diffuser.

7. The integrated illuminated fan of claim 6, wherein the light guide plate is disposed with multiple hooks, the diffuser is disposed with multiple notches corresponding to each hook, the conjoined fan frame comprises a surrounding plate, and each hook passes through each notch first and then is engaged with and fixed to the surrounding plate.

8. The integrated illuminated fan of claim 1, wherein each bearing portion comprises a load tray and multiple support rods connected with the load tray, one of the support rods is disposed with a wire trench, each stator assembly comprises a conductive wire, and each conductive wire separately passes through each wire trench.

9. The integrated illuminated fan of claim 1, further comprising multiple screwing elements, wherein the conjoined base comprises a bottom plate, the bottom plate is disposed with multiple sleeves, the conjoined fan frame comprises a top plate, the top plate is disposed with multiple threaded poles, and each screwing element corresponds to each sleeve to be connected and is fastened by each screwing element.

10. The integrated illuminated fan of claim 9, wherein four corners of the bottom plate are separately disposed with a positioning pole, four corners of the top plate are separately disposed with a countersink, and each positioning pole is embedded and positioned with each countersink.
